(19) United States
(12) Patent Application Publication
(10) Pub. No.: US 2005/0238782 A1
(43) Pub. Date: Oct. 27, 2005

(54) Alginate or low-methoxy pectate gel

(75) Inventors: Thomas Reid Kelly, Northants (GB); Bryan Edwin Barwick, Northants (GB); Vijay Arjun Sawant, Northants (GB)

Correspondence Address: STOUT, UXA, BUYAN & MULLINS LLP, 4 VENTURE, SUITE 300, IRVINE, CA, 92618, US

(73) Assignee: ISP Investments, Inc., Wilminton, DE (US)

(21) Appl. No.: 10/511,790

(22) PCT Filed: Apr. 17, 2003
(86) PCT No.: PCT/GB03/01657

§ 371 Date: Jun. 17, 2005

(30) Foreign Application Priority Data
Apr. 19, 2002 (GB) 0208999.3

(51) Int. Cl. A23L 1/05

(52) U.S. Cl. 426/573

(57) ABSTRACT

Our invention provides a highly convenient process and equipment which can be used to prepare alginate or low-methoxy pectate gels on site e.g. where the product is to be used. The process comprises making a sol in an in-line dynamic mixer, then introducing gelling ions, e.g. calcium ions, into the sol in the mixer and immediately subsequently allowing the sol to gel. The equipment consists of an in-line dynamic mixer with feed points for the alginate or low-methoxy pectate and water spaced sufficiently apart from a feed point for a source of gelling ions such that the sol is formed before it comes into contact with the gelling ions. The process can be used to prepare gelled particles for use as feed for live stock as well as to produce gels containing e.g. meat or fruit. A particular use is to produce feed containing sensitive ingredients e.g. live bacteria.

Alginate gels are well-known as are methods for their preparation by converting alginate in its sodium salt form, as a sol, into a gel by action of calcium ions.

Alginate gels have been used as foodstuffs e.g. petfoods, with meat in alginate gel, and simulated fruits, with pureed fruit in alginate gel.

Alginate sols are usually in the form of the sodium salt but other cations can be used to form sols. (Note that an inherent characteristic of an alginate sol is that the alginate is hydrated.) Similarly calcium ions are usually the cations that are used as gelling ions to convert such sols to gel form but other cations can be used. It is well-known that low-methoxy pectate behaves like alginate. For simplicity's sake we describe the background to our process and products in terms of sodium alginate and use of calcium ions to gel the sol but the use of low-methoxy pectate and other cations must always be borne in mind.

Broadly speaking there are three methods of converting an aqueous sol of sodium alginate to a gel. The first is by diffusion of calcium ions into an aqueous sol of sodium alginate. The second is by diffusion of hydrogen ions i.e. from an acid into an aqueous sol of sodium alginate containing a calcium salt the solubility of which is greatly increased by the hydrogen ions. The third is by mixing an aqueous sol of sodium alginate with a source of soluble calcium ions and allowing the mixture to gel without further mixing.

To obtain good quality gels it is well-known to be important that gelation occurs as far as possible in the absence of shear.

The third method has the major disadvantage over the other two methods that the sodium alginate sol is mixed with a source of soluble calcium ions and shearing at least at the start of gelation is unavoidable. All the methods of preparing acceptable gels have involved use of relatively complex systems and have required skills above that of an untrained person. We have invented a process and related equipment by which the third method can be used to prepare acceptable gels and in particular gel pieces with especially useful characteristics, even without the use of complex systems.

In a particular form of our invention our process and related equipment and products can be used for delivering therapeutic amounts of biologically active substances to humans and, in particular, to livestock.

An aspect of our invention is that we have discovered that alginate and low-methoxy pectate sols can advantageously be produced by adding a dispersion of alginate or low-methoxy pectate to water in an in-line dynamic mixer. Therefore our invention, in this aspect, provides a process for preparing an alginate or low-methoxy pectate sol in which a dispersion of alginate or low-methoxy pectate is mixed with water in an in-line dynamic mixer.

In a further and particularly important aspect of our invention we provide a process for preparing an alginate or low-methoxy gel in which water and a dispersion of alginate or low-methoxy pectate are mixed in an in-line dynamic mixer to produce a sol of alginate or low-methoxy pectate in the mixer and then free gelling ions are generated in the sol in the in-line mixer either a) by including in the water or in the dispersion of alginate or low-methoxy pectate a salt providing gelling ions when dissolved which salt is insoluble at neutral pH but soluble at acid pHs and by feeding an acid to the sol as an aqueous solution or as a dispersion or b) by feeding a dispersion of a salt providing gelling ions to the sol after which the resulting mixture is allowed to gel. (When option a) is used the salt insoluble at neutral pH is preferably included in the dispersion of alginate or low-methoxy pectate.)

Our process is particularly advantageous in that it provides a simple process for preparing alginate or low-methoxy pectate gels. It provides a process in which sols do not need to be prepared in advance. Preparation in advance inherently leads to the risk that not all the sol prepared will be needed. The sol is produced in-line, i.e. continuously. There is a major advantage in that our process does not involve use of vessels to store sols. Cleaning of such vessels is a major task. Our process also has the major advantage that it uses minimal and simple equipment which can be operated without complex training and can be used on site i.e. where the products are needed rather than in specialist factories from which the products have to be transported to the sites at which they will be used, with the inevitable risk that the amount of product delivered will be too little or too much.

In a preferred form of our invention after the free gelling ions have been generated in the sol in the sol in the in-line mixer the sol is allowed to gel quiescently immediately after leaving the in-line mixer. Firstly, it is most unexpected that gelling ions can be generated in the alginate or low-methoxy pectate sol in an in-line dynamic mixer without the resulting gel being of poor quality. Secondly, The process has great advantages in terms of simplicity as we also explain elsewhere.

Normally the dispersion of alginate or low-methoxy pectate and the water are fed to one end of the mixer and the free gelling ions are generated downstream such that the sol of alginate or low-methoxy pectate is formed before the mixture comes into contact with the free gelling ions.

The free gelling agents are preferably generated using alternative b) indicated above i.e. by feeding a dispersion of a low-solubility salt providing gelling ions to the sol.

The dispersant used i.e. for the alginate or low-ethoxy pectate, for the acid or for the low-solubility alt providing gelling ions is preferably an anhydrous liquid dispersant which disperses or dissolves in water. The dispersant should preferably be such that the alginate or low-methoxy pectate, the acid or the low-solubility salt can remain in suspension in the dispersant over periods of up to fifteen minutes without stirring. The liquid dispersant should also preferably have lubricating properties e.g. to be readily pumpable in conventional progressive cavity pumps; the type of pump which can conveniently be used for delivering the dispersed alginate or low-methoxy pectate or the low-solubility salt providing gelling ions to the in-line mixer. Such lubricating properties are less important when piston pumps are used. Examples of suitable liquid dispersants are oils, glycerol and polyols. When the process is used to prepare a gel for feeding to livestock, the oil advantageously is an edible oil preferably containing lecithin e.g. a vegetable oil containing about 10% lecithin. Water itself would produce a slurry which could not be pumpable in conventional progressive cavity pumps.

A feature of our invention is that there is reduced need to use calcium sequestrants.

In a specific form our process provides an advantageous system for preparing alginate or low-methoxy pectate gels containing therapeutic amounts of biologically active substances, including but not limited to vitamins, enzymes and bacteria, especially those which are best kept in a protected environment e.g. dry or anaerobic till they are fed to patients or livestock.

In a special aspect of our invention such therapeutic amounts of biologically active substances can be incorporated in the dispersion of alginate or low-methoxy pectate or in the water or in the acid or in the dispersion of low-solubility salt providing gelling ions depending on the sensitivity of the active substance to water and to acid.

It is also convenient to incorporate other components in the dispersion of alginate or low-methoxy pectate, in the water or in the dispersion of salt providing gelling ions or in the acid fed to the sol to generate gelling ions. For instance this obviates the need for using very small dosing pumps. It also helps prevent settling out of the salt providing gelling ions.

An advantage of our process is that it can be performed at ambient temperature, in particular at low ambient temperatures i.e. at temperatures below 30° C. especially below 20° C. Of course the temperature must be above freezing point e.g. above 0° C. Use of low temperatures helps avoid deterioration of active ingredients. e.g. heat-sensitive ingredients such as biologically active additives useful for optimal health and nutrition.

A further advantage of our process is that it can achieve the uniform incorporation of attractants which e.g. can substantially increase the probability of consumption by the livestock e.g. green colour for chicks and species-specific attractants in the fishing industry e.g. in fish farming. When being used to prepare gels for use in fish farming it is advantageous to include air when mixing the dispersion of alginate or low-methoxy pectate with the water and/or when mixing them with the calcium-ion generating system.

As mentioned above our process does not involve the use of complex systems or expensive equipment. Thus a further advantage of our process is that our process and equipment can be operated on demand and by relatively untrained people on site using minimal equipment and, without e.g. requiring the preservation of ingredients in an active state during transport and storage.

Our invention can particularly advantageously be used to produce an alginate or low-methoxy pectate gel containing a sensitive ingredient which requires an aqueous environment and which requires to be fed, e.g. to livestock, shortly, e.g. within 30 minutes, after being introduced to an aqueous environment. Indeed we have found, although the products of our process are particularly advantageous in this respect, that alginate or low-methoxy pectate gels are excellent delivery media for such sensitive ingredients. Such gels deliver water, useful for the livestock and useful for certain biologically active materials e.g. bacteria but without excess free water, which can lead to problems e.g. hypothermia. Important examples of such sensitive ingredients are anaerobic bacteria and in a particularly important form of our invention a product is formed comprising anaerobic bacteria dispersed in alginate or low-methoxy pectate gel in which any water used is de-aerated water. For instance the water mixed with the dispersed alginate or low-methoxy pectate in our process contains dispersed anaerobic bacteria.

The water can be de-aerated by adding salts which generate carbon dioxide or simply by the addition of solid carbon dioxide in which the anaerobic bacteria have been delivered. The former is preferred because salts can be used which contain minor ingredients which are beneficial to the anaerobic bacteria.

The ratio of alginate or low-methoxy pectate to calcium can be adjusted to get adequate dryness with lack of significant syneresis and adequate strength. The process enables attainment of fast setting times e.g. within about 11 minutes of addition or production of the gelling ions. Adequate dryness is achieved by increasing the amount of the alginate or low-methoxy pectate; adequate strength comes from increasing the level of salt providing gelling ions. Increasing the amount of salt providing gelling ions, without increasing the amount of alginate or low-methoxy pectate, will speed up the gelling rate and increase the gel strength but speeding up the gelling rate too much will increase syneresis.

Preferred sizes are particles of about 1 to 4 mm in maximum dimension but larger particles can be used if they are sufficiently friable.

As mentioned above alginate and low-methoxy pectate gels have been used to prepare meat products such as petfoods and to prepare simulated fruit products. Our process is a particularly simple and convenient way of making such products. The meat or fruit in pumpable form is advantageously included in the water used in the process but also can be included in the dispersion of alginate or low-methoxy pectate or in the dispersion of salt providing the gelling ions or in the acid fed to the sol to generate gelling ions.

Equipment according to the invention consists of an in-line dynamic mixer with feed points through which a) a dispersion of alginate or low-methoxy pectate, b) water and c) a source of gelling ions e.g. a dispersion of a low-solubility salt providing gelling ions can be separately fed to the mixer, feed points a) and b) being sufficiently spaced up-stream of feed point c) that in use the alginate or low-methoxy pectate forms a sol with the water before it comes into contact with gelling ions.

Dynamic mixers contrast with static mixers. In the latter the ingredients to be mixed are divided and mixed repeatedly. Dynamic mixers are a well-known class of mixers. An example of a dynamic mixer used in-line is the mini-Mondo mixer; it is a baffled turbine mixer. Such a mixer can be used in our process. However it was designed with aeration as a principal use and our process, although it can be used to prepare aerated products, is principally used to prepare non-aerated products.

The best way of defining the throughput speeds and mixing characteristics to be used in an in-line mixer for use in our invention is that they ensure formation of the sol before the gelling ions are generated. But a useful minimum tip speed of rotors is 1500 rpm. The sol is made the more quickly the higher the shear e.g. the higher the tip speed of rotors.

As mentioned above for convenience we describe our process and products initially in terms of the sodium form of alginate as a sol and gelation using calcium ions from salt providing gelling ions but that other cations can be used. Similarly we mention above that it is well-known that low-methoxy pectate has very similar characteristics to alginate.

“Low-methoxy pectate” is a well-known term. Normally low-methoxy pectates are considered to be pectates (i.e. pectins) containing less than 50% methoxylated carboxyl groups. For the process of this invention the low-methoxy pectate should preferably contain less than 30% methoxylated carboxyl groups.

As mentioned the sodium salt is a particularly convenient form of alginate or low-methoxy pectate from which to form a sol. The alginate or low-methoxy pectate used to form the products of the invention is preferably sodium alginate of high molecular weight (of the order of 100,000). Alginates having a low content of mannuronic acid residues (mannuronic: guluronic ratio less than 1:1) are especially suitable. The proportion of alginate or low-methoxy pectate used varies with its gelling ability (that is, the gel strength obtained per unit weight) and with the texture desired in the final product, in particular in the gel pieces. We have found that when the preferred sodium alginate is used it suitably forms from 0.4% to 4% by weight of the product formed. Other cations can be used to form sols with alginate or low-methoxy pectate e.g. potassium and ammonium.

Calcium sulphate (particularly in the dihydrate form) is the especially preferred low-solubility calcium salt to be used in the invention. However any salt providing gelling ions which has low solubility in water e.g. in the aqueous sol can be used. Salts with a solubility less than 3.5% (weight percentages) are preferred, particularly preferably those with a solubility less than 1% and especially those with a solubility less than 0.3% but above a solubility of 0.02% e.g. calcium sulphate anhydrous, calcium sulphate dihydrate, calcium citrate and calcium tartrate. For some purposes a small amount, e.g. providing 2% of the calcium ions, of a soluble calcium salt such as calcium lactate can be included.

When the salt is a salt insoluble at neutral pH but soluble at acid pHs, preferred calcium salts include calcium citrate, calcium tartrate, calcium carbonate and calcium phosphates. Dicalcium phosphate dihydrate and dicalcium phosphate anhydrous are particularly preferred, especially dicalcium phosphate dihydrate.

It can be difficult to avoid the presence of some calcium ions in the water with which the alginate is mixed. But such presence of gelling ions is disadvantageous and at least 98% of the gelation of the alginate has to be due to the generation or addition of the gelling ions.

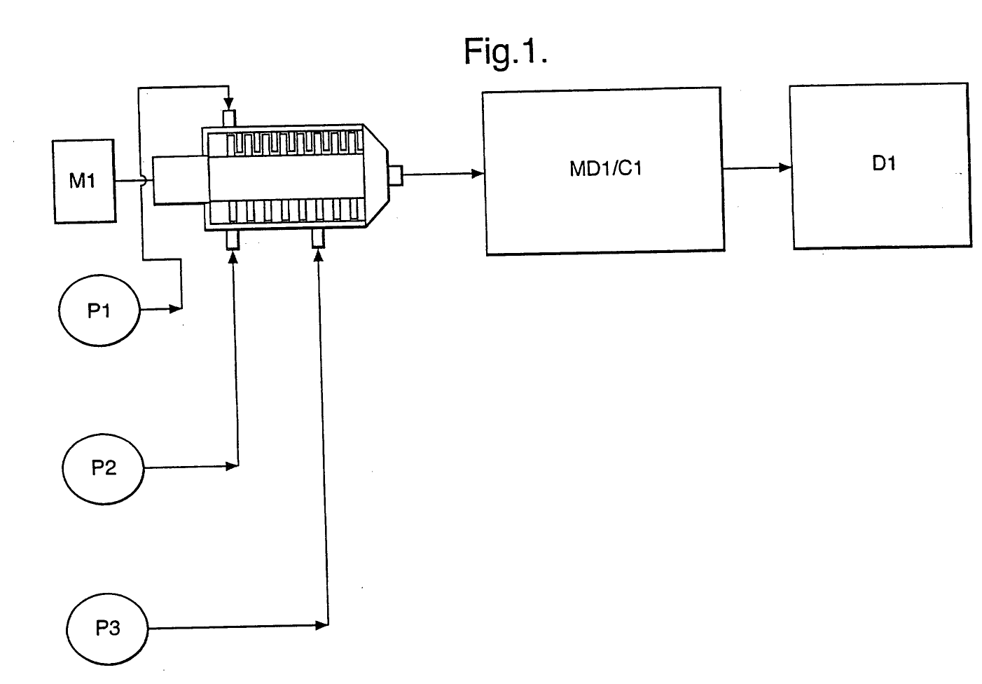

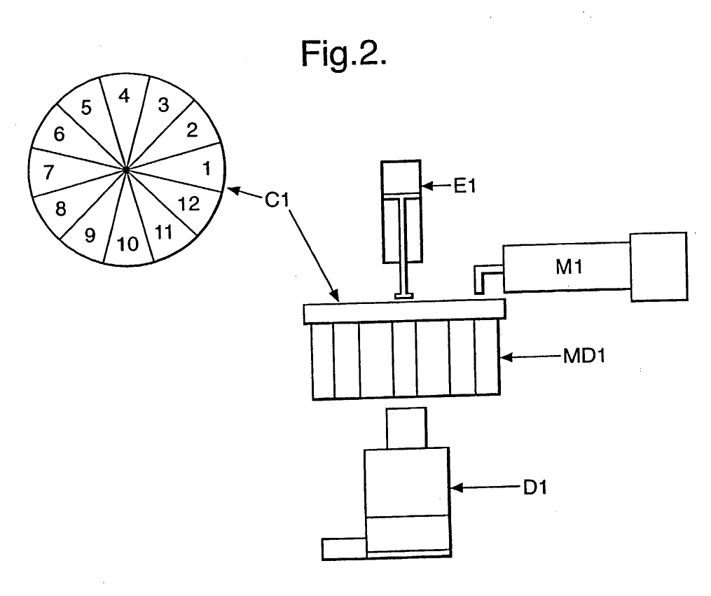

Our process, equipment and products will be now described by way of example with reference to FIGS. 1 and 2.

FIG. 1 is an overall flow diagram.

FIG. 2 shows more detail of the gelling and dicing.

The quantities of ingredients were:

| | % |
|---|---|
| | (by weight) |
| Water feed: | |
| De-aerated water | 90 |
| Anaerobic bacteria plus minor ingredients | 0.56 |
| Alginate feed: | |
| Sodium alginate (Manugel DMB*) | 3.50 |
| Oil blend** | 3.00 |
| Calcium sulphate feed: | |
| Calcium sulphate dihydrate | 0.80 |
| Chick feed | 1.00 |
| Oil blend | 1.14 |
| Total | 100 |

*Trade Mark of ISP Alginates
**Oil blend: Vegetable oil 90%, lecithin 10%

Sodium alginate is dispersed in vegetable oil containing 10% lecithin. Anaerobic bacteria, supplied as beadlets packed in solid carbon dioxide, are dispersed in deaerated water. The beadlets contain micro-ingredients to help activate and increase the growth rate of the anaerobic bacteria. The water was deaerated by adding salts which generated carbon dioxide.

The dispersion of sodium alginate in vegetable oil containing 10% lecithin and the dispersion of anaerobic bacteria in water were fed to an in-line dynamic mixer M1 by pumps P1 and P2 at rates 108.67 kg/hr and 7.8 kg/hr respectively. The mixer M1 was a 2 kw mixer and was operated at 2800 rpm. It has nine rotators on a central shaft, each rotator bearing four equally spaced pins with a tip to tip diameter of 66 mm. The central shaft has a diameter of 35 mm. The pins rotate between stators. The water and the dispersion of sodium alginate were fed to the in-line dynamic mixer through inlets aligned with the first rotator.

Calcium sulphate was dispersed in oil together with milled chick feed and fed by pump P3 at 3.53 kg/hr to the in-line dynamic mixer M1 through an inlet aligned with pin 7. The alginate was hydrated i.e. in sol form by the time it reached pin 6 i.e. before being mixed with the calcium sulphate. The chick feed optimally contains a green colorant as this adds to the palatability of the product to chicks. The resulting mix was fed to moulds MD1 in which the alginate gelled quiescently. The moulds MD1 were set in a carousel C1 which rotated at 11 minutes per revolution. At stage 10 the mix which by that time had gelled was ejected by an ejector E1 into a Hobart dicer D1 where it was broken down into particles of 3 mm diameter. The product was attractive and beneficial to chicks.

1-25. (canceled)

26. A process for preparing an alginate gel or low-methoxy pectate gel comprising:
step 1) mixing water and a dispersion of alginate or low-methoxy pectate in an in-line dynamic mixer thereby producing an aqueous alginate sol or an aqueous low-methoxy pectate sol, then
step 2) generating free gelling ions in the aqueous alginate sol or the aqueous low-methoxy pectate sol in the in-line dynamic mixer either a) by including in the water or in the dispersion of alginate or low-methoxy pectate a salt providing gelling ions when dissolved which is insoluble at neutral pH but soluble at acid pHs and by feeding an acid to the sol as an aqueous solution or as a dispersion or b) by feeding a dispersion of a low-solubility salt providing gelling ions to the sol, and
step 3) allowing the aqueous alginate sol or the aqueous low-methoxy pectate sol to gel after the aqueous alginate sol or the aqueous low-methoxy pectate sol has left the in-line dynamic mixer.

27. A process according to claim 26 in which the aqueous alginate sol or the aqueous low-methoxy pectate sol is allowed to gel quiescently immediately after the aqueous alginate sol or the aqueous low-methoxy pectate sol has left the in-line dynamic mixer.

28. A process according to claim 26 in which the free gelling ions are generated by feeding to the sol a dispersion of a low-solubility salt providing gelling ions.

29. A process according to claim 26 in which a dispersant is used to prepare the dispersion of the alginate or low-methoxy pectate, of the acid or of the low-solubility salt, which dispersant is an anhydrous liquid dispersant which disperses or dissolves in water.

30. A process according to claim 29 in which the dispersant is such that the alginate or low-methoxy pectate, the acid or the low-solubility salt can remain in suspension in the dispersant over periods of up to fifteen minutes without stirring.

31. A process according to claim 30 in which the dispersant has lubricating properties.

32. A process according to claim 31 in which the dispersant is an edible oil containing lecithin.

33. A process according to claim 28 in which the low-solubility salt providing gelling ions has a solubility in the sol of less than 3.5%.

34. A process according to claim 28 in which the low-solubility salt providing gelling ions has a solubility in the sol of less than 1%.

35. A process according to claim 34 in which the salt has a solubility in the sol of less than 0.3% but above 0.02%.

36. A process according to claim 35 in which the low-solubility salt providing gelling ions is a calcium salt.

37. A process according to claim 36 in which the calcium salt is selected from the group consisting of calcium sulphate anhydrous, calcium sulphate dihydrate, calcium citrate, calcium tartrate and mixtures thereof.

38. A process for preparing an alginate gel or low-methoxy pectate gel according to claim 26 in which in step 1) meat or fruit in pumpable form is mixed with the aqueous alginate sol or the aqueous low-methoxy pectate sol in the in-line dynamic mixer.

39. A process for preparing an alginate gel or low-methoxy pectate gel according to claim 26 in which therapeutic amounts of biologically active substances are included in the in-line dynamic mixer.

40. A process according to claim 39 in which anaerobic bacteria are the biologically active substances and the anaerobic bacteria are introduced into the in-line dynamic mixer by incorporation into the water in step 1).

41. A process according to claim 39 in which the gel formed in step 3) is broken into portions on site.

42. A product of a process according to claim 26.

43. A process in which a product of a process according to claim 41 is fed to livestock.

44. A process according to claim 43 in which the time between the end of step 2) and the product being fed to livestock is less than 30 minutes.

45. A process according to claim 44 in which the livestock are chicks.

46. A feedstock for livestock which livestock require water but are sensitive to free water in the livestock's environment consisting of a product of claim 41.

47. A feedstock for chicks consisting of a product of claim 41.

48. A system comprising an in-line dynamic mixer with feed points through which a) a dispersion of alginate or low-methoxy pectate, b) water and c) a source of gelling ions can be separately fed to the mixer, feed points a) and b) being spaced sufficiently up-stream of feed point c) such that in use the alginate or low-methoxy pectate forms an aqueous alginate sol or a low-methoxy pectate sol before alginate or low-methoxy pectate comes into contact with the gelling ions, and a receptacle to receive the aqueous alginate sol or the low-methoxy pectate sol, the receptacle being such that the aqueous alginate sol or the low-methoxy pectate sol is maintained quiescently to produce an alginate gel or low-methoxy pectate gel.

49. A system according to claim 48 further comprising on site means to break the alginate gel or low-methoxy pectate gel into feedstock size portions.
